(19) United States
(12) Patent Application Publication
(10) Pub. No.: US 2020/0208368 A1
(43) Pub. Date: Jul. 2, 2020

(54) Waste Management System

(71) Applicant: Philip John Milanovich, Butte, MT (US)

(72) Inventor: Philip John Milanovich, Butte, MT (US)

(21) Appl. No.: 15/993,324

(22) Filed: May 30, 2018

(51) Int. Cl. E02B 15/10; B02C 21/02; B02C 23/38

(52) U.S. Cl. CPC E02B 15/104; B02C 23/38; B02C 21/026; E02B 15/10

(57) ABSTRACT

A waste management system, primarily intended to be for waste floating in water, though it can also be used on land. A shredding device will reduce the size of the particles of waste. Ocean water is removed by a drying device. The dried waste material is cryogenically frozen using liquid nitrogen or other suitable means. The frozen waste material is then pulverized and ground into a powder. The powder may then be sprayed into a gas-filled chamber and heated. Temperature, pressure and humidity are maintained within the chamber for more than one minute. Microwave or other radiation and catalysts may be used to enhance the process of extraction. The processed material is then removed from the chamber. Carbon and water may be recycled. The carbon may be used as fuel by the ship. Water may also be used by the ship or returned to the ocean in a non-toxic condition.

### BACKGROUND OF THE INVENTION

### 1. Field of the Invention

The present invention relates to apparatus, methods and systems for waste management,

### 2. Description of the Prior Art

The accumulation of non-biodegradable waste on both land and sea is a major environmental problem that is rapidly getting worse. The accumulation of plastic in the world's oceans is a particularly serious problem. The “Pacific Garbage Patch”, which is mainly plastic floating in an area of the Pacific Ocean, is now twice the size of the state of Texas.

U.S. Pat. No. 1,739,761, issued on Dec. 17, 1929, to Henry F. Kleinfeldt, discloses a method of freezing “gummy, pasty, or viscous material” using “dry ice”, then grinding or pulverizing it. The instant invention is distinguishable, because the waste material can be cooled to a lower temperature using liquid nitrogen, and it can be used for waste on the ocean's surface.

U.S. Pat. No. 2,609,150, issued on Sep. 2, 1952, to Robert E. Bludeau, discloses mechanical pulverization of refrigerated plastics, which are super-cooled using liquid nitrogen. The instant invention is distinguishable, because it has an assembly-line process that may be used on an ocean's surface.

U.S. Pat. No. 3,995,816, issued on Dec. 7, 1976, to Herbert Motek, discloses fragmentation of automobile tires by freezing them using liquefied gas, then dropping them into an impact mill. The instant invention is distinguishable, because it has an assembly-line process that may be used on an ocean's surface.

U.S. Pat. No. 4,025,990, issued on May 31, 1977, to Norris G. Lovette, Jr., discloses a process in which scrap tires are cooled in a cryogenic freezer, comminuted and passed through a series of screening and density classification operations, followed by magnetic material separation and further cryogenic size reductions to produce a rubber crumb having a particle sized of about 1/20 inch or less. The instant invention is distinguishable, because it has an assembly-line process that may be used on an ocean's surface.

U.S. Pat. No. 4,409,034, issued on Oct. 11, 1983, to Roger F. Williams, discloses cleaning material from the surfaces of a structure by directly or indirectly using a cryogenic or refrigerant liquid. The instant invention is distinguishable, because it cleans waste from the world's water and land surfaces.

U.S. Pat. No. 4,575,427, issued on Mar. 11, 1986, to Ysern de Acre and Giovvani Crosti Soldattti, discloses the conversion of resinous paint sludge from commercial spray-gun operations into a granulate material using cryogenic freezing and crushing. The instant invention is distinguishable, because it is not limited to treating only one source of waste material.

U.S. Pat. No. 4,813,614, issued on Mar. 21, 1989, to David R. Moore and Curry L Aten, discloses treating waste products, such as vehicle tires, to recover their components, by cooling them to the temperature of crystallization of their components, as by spraying them with liquid nitrogen, then crushing them and separating the components. The instant invention is distinguishable, because it cleans waste from the world's water and land surfaces.

U.S. Pat. No. 5,368,240, issued on Nov. 29, 1994, to Oliver Bonnet, discloses an apparatus for reducing scrap rubber to particles, including an inclined pre-cooling tunnel with a conveyor, and a main cooling tunnel filled with a cooling medium (which may be liquid nitrogen) with a conveyor and a size reduction device. The instant invention is distinguishable, because it is not limited to treating only one source of waste material, and has an assembly-line process that may be used on the ocean's and the land's surface.

U.S. Pat. No. 5,385,307, issued on Jan. 31, 1995, to Essa T. Azar, discloses a cryogenic tire recycling system, wherein the tires are cut up and frozen using liquid nitrogen, fractured using robot arms, and their components are then separated. The instant invention is distinguishable, because it is not limited to treating only one source of waste material, and has an assembly-line process that may be used on the ocean's and the land's surface.

U.S. Pat. No. 5,588,600, issued on Dec. 31, 1996, to Kenneth F. Perfido and Anthony M. Cialone, discloses a process for recovering crumb rubber from used vehicle tires, including three comminuting operations, the second and third of which begin with contact with a liquid cryogenic (such as nitrogen). The instant invention is distinguishable, because it is not limited to treating only one source of waste material, and has an assembly-line process that may be used on the surface of both the land and the sea,

U.S. Pat. No. 5,735,471, issued on Apr. 7, 1998, to Louis Muro, discloses a cryogenic tire disintegration process, comprising the step of freezing elastomeric into a brittle glass-like state, and the step of gradual disintegration of the frozen segments. The instant invention is distinguishable, because it is not limited to treating only one source of waste material, and has an assembly-line process that may be used on the surface of both the land and the sea.

U.S. Pat. No. 5,842,650, issued on Dec. 1, 1998, to Juergen Hofmann, discloses a method for breaking up elastic material combined with metallic elements, in which the composite material is placed into an insulated vat holding liquid nitrogen, and then is subjected to high-energy electric pulses. The instant invention is distinguishable, because it has an assembly-line process that may be used on the surface of both the land and the sea.

U.S. Pat. No. 5,971,307, issued on Oct. 26, 1999, to Ricky W. Davenport, discloses an in-line rotary grinder. The instant invention is distinguishable, because in it the material to be ground is first cryogenically frozen.

U.S. Pat. No. 6,668,562, issued on Dec. 30, 2003, to Robert A. Shatten, John Carrier and Johnny Dean Jackson, discloses a system that may be used to convert rubber in tires to rubber crumb, using both liquid natural gas and liquid nitrogen. The instant invention is distinguishable, because it has an assembly-line process that may be used on the surface of both the land and the sea.

U.S. Pat. No. 7,425,315, issued on Sep. 16, 2008, to Paul R. Kruesi, discloses a method to recapture energy from organic waste. The instant invention is distinguishable, because in it the waste material is first cryogenically frozen, and then pulverized into small particles having a large total surface area on which reactions can take place.

U.S. Pat. No. 8,888,671, issued on Nov. 18, 2014, to John Eirik Paulsen, discloses a method for disposal of drilling waste, contaminated sediments and residual waste, and a disposal facility for same, in which the waste is ground up, mixed with binder, and allowed to set like concreate on the bottom of the sea floor. The instant invention is distinguishable, because it seeks to recycle as much of the waste as possible.

U.S. Pat. No. 9,415,327, issued on Aug. 16, 2016, to Cyrille Fargier and Philippe Montrocher, discloses a device for collecting and separating aqueous and/or oily liquids and cryogenic liquid. The instant invention is distinguishable, because it is designed to remove solid wastes from the environment.

Soviet Patent No. 1458661, published on Feb. 15, 1989, to G. D. Gamulya, A. P. Nazrenko and V. G. Solyanko, discloses an apparatus for recycling used tires, in which the tires are sprayed with a cryogenic agent, rather than dipped in a vat. The instant invention is distinguishable, because it is not limited to treating only one source of waste material, and has an assembly-line process that may be used on the surface of both the land and the sea.

Japanese Patent No. 7-68192, published Mar. 14, 1995, to Osorini Piero, Frederic Eimgartner and Edito Eimgartoner, discloses a supercentrifugal pulverizer and a method for pulverizing thermosensitive material at low temperatures. The instant invention is distinguishable, because it has an assembly-line process that may be used on the surface of both the land and the sea.

Japanese Patent No. 11-104510, published Apr. 20, 1999, to T. Kondo et al., discloses a rotary freezing drum for cryogrinding of rubber in recycled tires. The instant invention is distinguishable, because it is not limited to treating only one source of waste material.

PCT International Patent Application Publication No. WO 94/07670, published on Apr. 14, 1994, discloses cryogenic processing of used tires, wherein old tires are cut into strips, cooled in liquid nitrogen to make the rubber brittle, and the frozen strips are fed through pinch rollers. The instant invention is distinguishable, because it is not limited to treating only one source of waste material.

PCT International Patent Application Publication No. WO 2011/155667, published on Dec. 15, 2011, discloses a device for manufacturing solid fuel using a mixture of ocean waste and combustible waste. The instant invention is distinguishable, because it has a means of scooping up waste from the surface of the sea, and using it as fuel for the ship.

None of the above inventions and patents, taken either singly or in combination, is seen to describe the instant invention as claimed.

### SUMMARY OF THE INVENTION

The present invention is a waste management system, primarily intended to be for waste material floating on an ocean's surface and subsurface, though it can also be used on land. When used to collect waste floating on the ocean's surface and subsurface, a ship (or other vessel) having a specially designed bow may be used. This invention is designed to treat macro-plastic and micro-plastic. Macro plastic floats on or near the surface of the water. Micro-plastics are concentrated in the top five meters of the water (i.e., the “subsurface”). The concentration of micro-plastics falls exponentially with depth, with 90% being in the top five meters of the water.

The waste may be forced by the ship's motion onto a conveyor belt, or a net, dragline, paddlewheel, vacuum pump, screw or other suitable means of movement may be used. A shredding device will reduce the size of the particles of waste. Ocean water is removed by a drying device. The dried waste material is cryogenically frozen using liquid nitrogen or other suitable means. The frozen waste material is then pulverized and ground into a powder. The powder may then be sprayed into a gas filled chamber and heated. Steam may be used to maintain humidity within the chamber. Pressure within the chamber may be maintained at 0.25 to 500 atmospheres. Temperature, pressure and humidity should be maintained within the chamber for more than one minute. Microwave or other radiation and catalysts may be used to enhance the process of extraction. The processed material is then removed from the chamber. Carbon and water may be recycled. The carbon may be used as fuel by the ship. Water may also be used by the ship or returned to the ocean in a non-toxic condition.

Accordingly, it is a principal object of the invention to provide a means for clearing the world's seas of floating plastic.

It is another object of the invention to provide a means for clearing both land and sea of non-biodegradable waste generally.

It is a further object of the invention to recover carbon as fuel from waste materials.

Still another object of the invention is to recover purified water from waste materials.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a flow chart of the preferred embodiment of the invention.

FIG. 2 is a top plan view of a vessel in the preferred embodiment of the invention, having its bow in a closed position.

FIG. 3 is a top plan view of a vessel in the preferred embodiment of the invention, having its bow in an expanded open position.

FIG. 4 is a perspective view of a pump in the preferred embodiment of the invention.

FIG. 5 is a side elevation view of a paddle in the preferred embodiment of the invention.

FIG. 6 is a front elevation view of a rake in the preferred embodiment of the invention.

FIG. 7 is a right side elevation view of a net or dragline in the preferred embodiment of the invention.

FIG. 8 is a perspective view of a bucket in the preferred embodiment of the invention.

FIG. 9 is a front elevation view of a shovel in the preferred embodiment of the invention.

FIG. 10 is a front elevation view of a fork in the preferred embodiment of the invention.

FIG. 11 is a front elevation view of a spoon in the preferred embodiment of the invention.

FIG. 12 is a side elevation view of a conveyor belt in the preferred embodiment of the invention.

FIG. 13 is a perspective view of a drone in the preferred embodiment of the invention.

FIG. 14 is a side elevation view of a vessel with cameras in the preferred embodiment of the invention.

FIG. 15 is a side elevation view of a vessel with a laboratory in the preferred embodiment of the invention.

FIG. 16 is a front elevation view of a chamber in the preferred embodiment of the invention.

FIG. 17 is a top plan view of a plurality of the chambers on a rotating table in the preferred embodiment of the invention.

FIG. 18 is perspective view of a dryer removing moisture from waste material in the preferred embodiment of the invention.

FIG. 19 is a side elevation view of a robotically controlled surface waste collection vessel in the preferred embodiment of the invention.

FIG. 20 is a side elevation view of a robotically controlled subsurface waste collection vessel in the preferred embodiment of the invention.

FIG. 21 is a side elevation view of a collecting mechanism with a screen that may be extended in the preferred embodiment of the invention.

Similar reference characters denote corresponding features consistently throughout the attached drawings.

### DETAILED DESCRIPTION OF THE PREFERRED EMBODIMENT

The present invention is a waste management system.

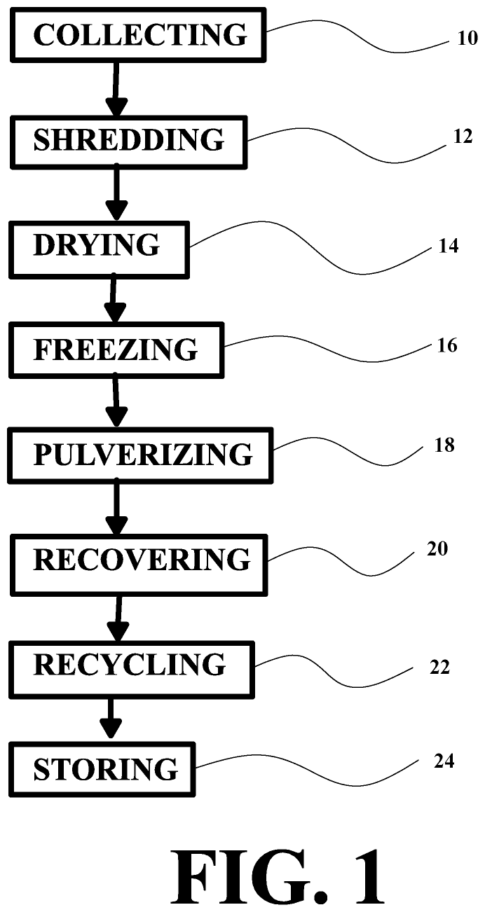

FIG. 1 is a flow chart of the preferred embodiment of the invention, showing a method of waste management, comprising the steps of:

collecting waste material 10;

shredding the waste material 12;

drying the waste material 14;

cryogenically freezing the waste material 16;

pulverizing the waste material, to maximize the ratio of the surface area to volume of particles of the waste material 18;

recovering useful material from the waste material 20;

recycling the recovered useful material 22; and

storing the recovered useful material 24.

The waste material should be frozen to a temperature below zero degrees Celsius, preferably below one hundred fifty degrees Celsius. Cyrogenic means very cold. Liquid nitrogen, a solution of dry ice and ethanol, or other suitable means of cryogenic freezing may be used. Material that is cryogenically frozen tends to crystallize and become brittle, and therefore easier to pulverize into small particles. The ratio of the surface area to volume increases as particles become small, due to the square-cube law, which states: When an object undergoes a proportional increase (or decrease) in size, it new surface area is proportional to the square of the multiplier, and its new volume is proportional to the cube of the multiplier. (In the case of a decrease, the multiplier will be a fraction.) As smaller particles have a relatively larger surface area on which chemical reactions can take place, they may be more easily converted by chemical reactions into a useful form.

A gas is used in the recovery of the useful material that reacts with the waste material. The gas is preferably a carbon oxide gas, such as carbon monoxide or carbon dioxide. The waste material may include plastic or any carbon containing material. The waste material may be collected from land or from water. It may be collected from the surface or the subsurface of a body of water, such as an ocean, sea, lake or river.

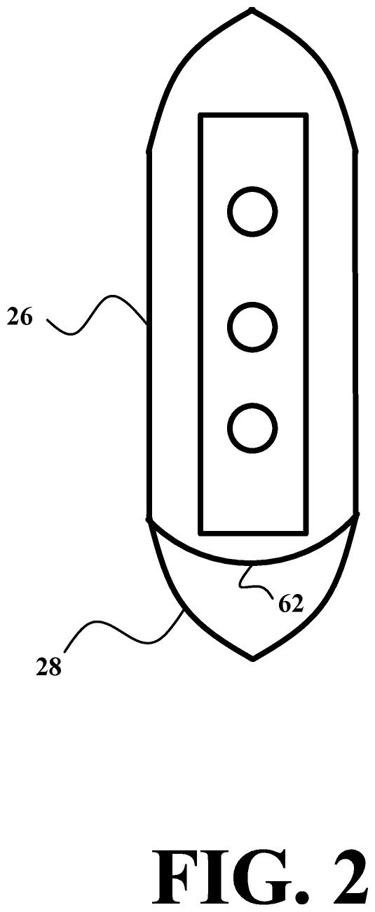

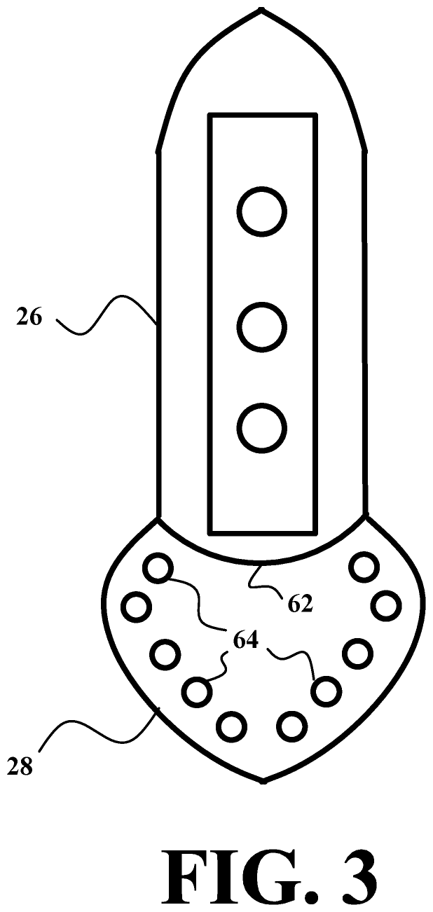

The waste material may be collected using a ship, boat or other vessel. The vessel may have a bow that can open up to a greater width than the vessel's beam. FIG. 2 is a top plan view of the vessel 26 in the preferred embodiment of the invention, having its bow 28 in a closed position. FIG. 3 is a top plan view of the vessel 26 in the preferred embodiment of the invention, having its bow 28 in an expanded open position. The waste material may also be collected and moved into the vessel using the movement of the vessel, or the current flow in the body of water.

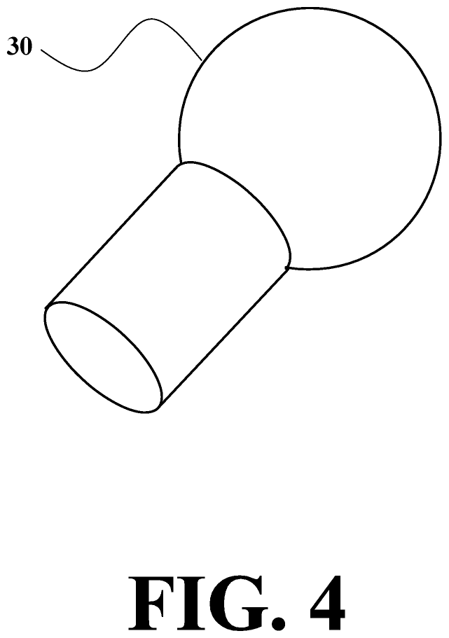

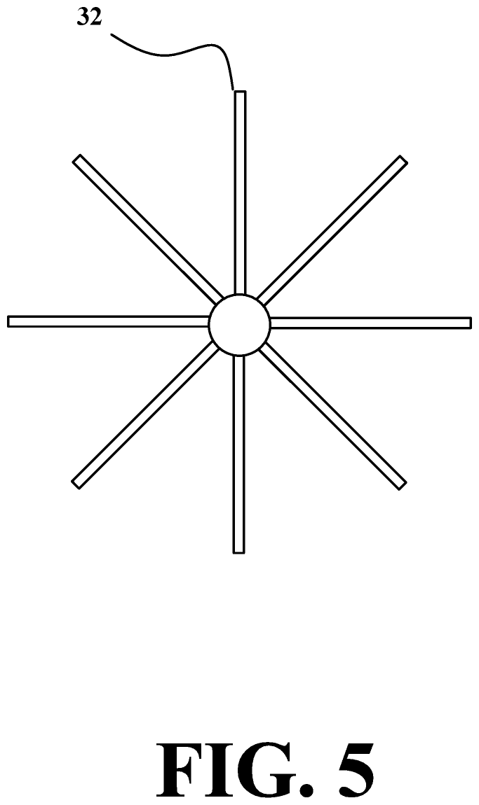

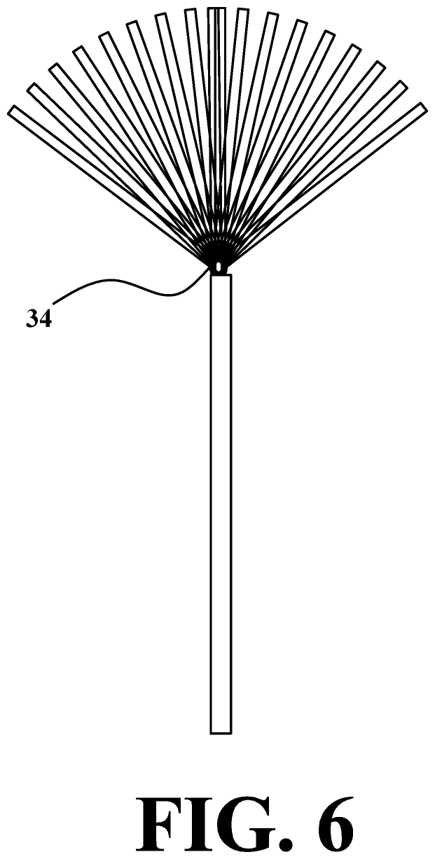

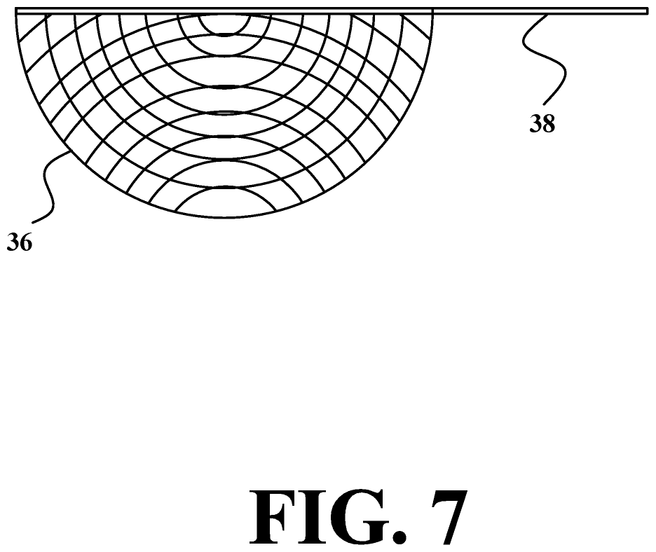

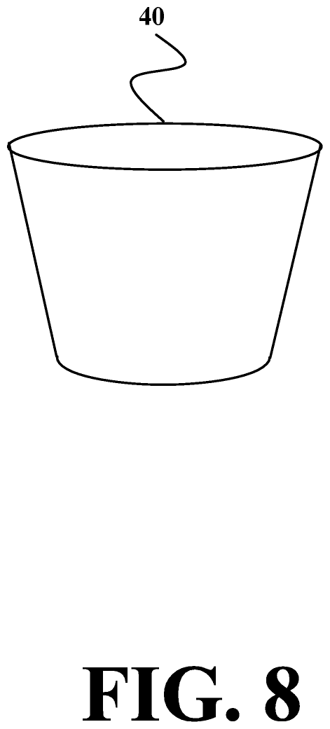

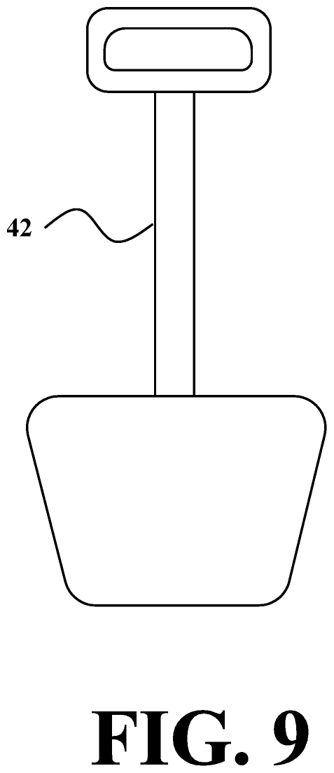

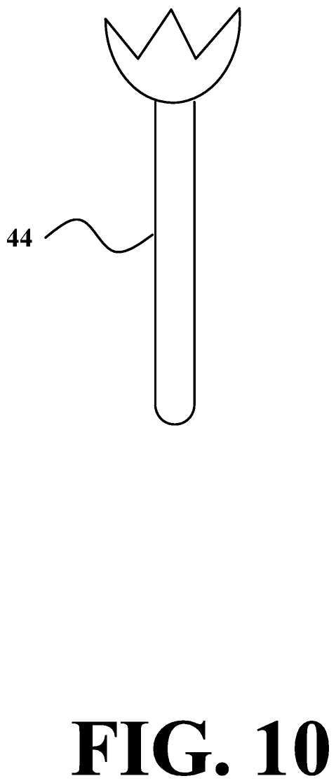

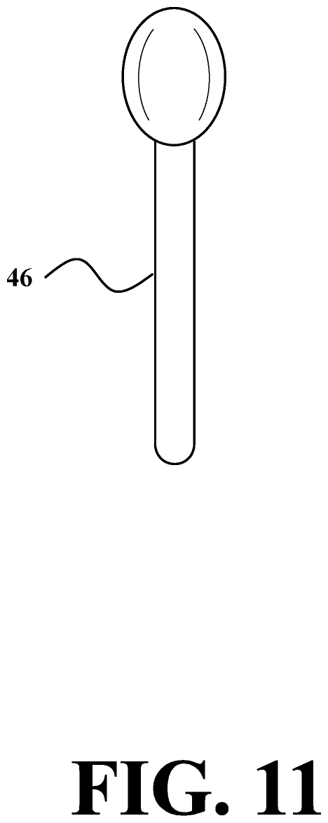

The waste material may be collected using pumps 30 in FIG. 4, paddles or paddlewheels 32 in FIG. 5, rakes 34 in FIG. 6, nets 36 or draglines 38 in FIG. 7, buckets 40 in FIG. 8, shovels 42 in FIG. 9, forks 44 in FIG. 10, spoons 46 in FIG. 11, or any other suitable devices, and moved into the vessel or other suitable container.

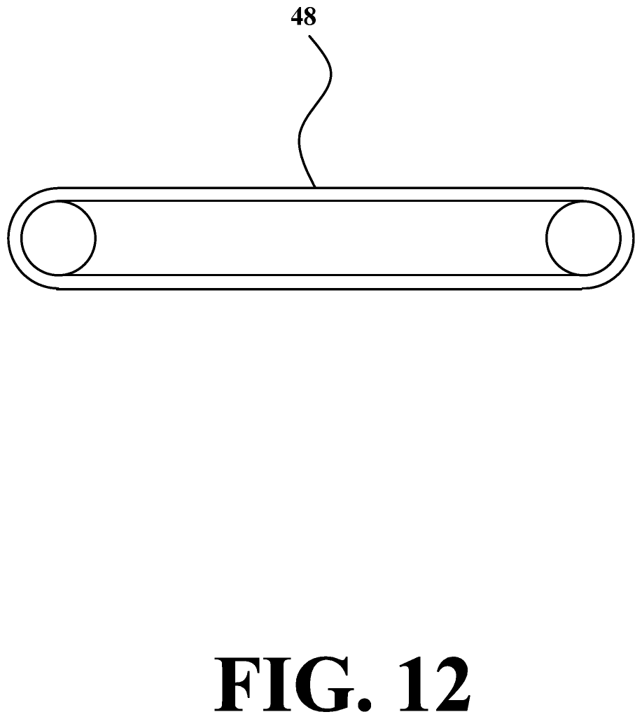

FIG. 12 is a side elevation view of a conveyor belt 48 in the preferred embodiment of the invention, which is used to collect waste material from the water or land, into a vessel or other suitable container. The conveyer belt is capable of movements including extension, retraction, raising, lowering, and titling at an angle, to help collect and move the waste material.

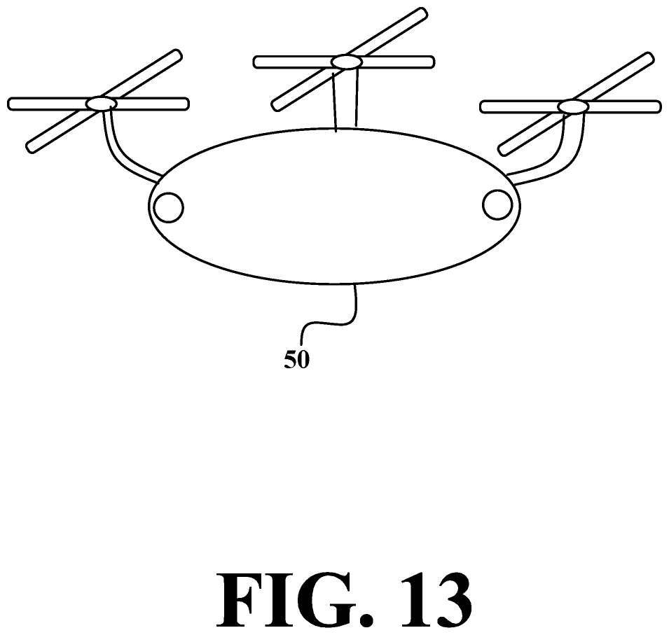

FIG. 13 is a perspective view of a drone 50 in the preferred embodiment of the invention, which can be used to monitor the waste material.

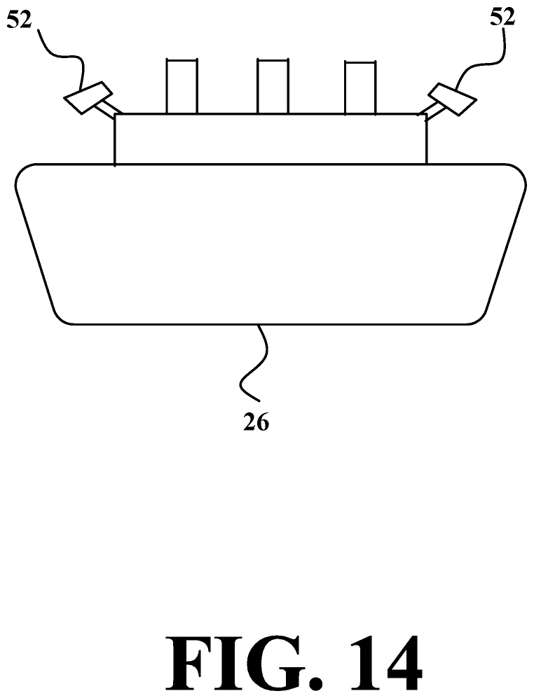

FIG. 14 is a side elevation view of a vessel with cameras 52 in the preferred embodiment of the invention. The cameras can be used to monitor the waste material.

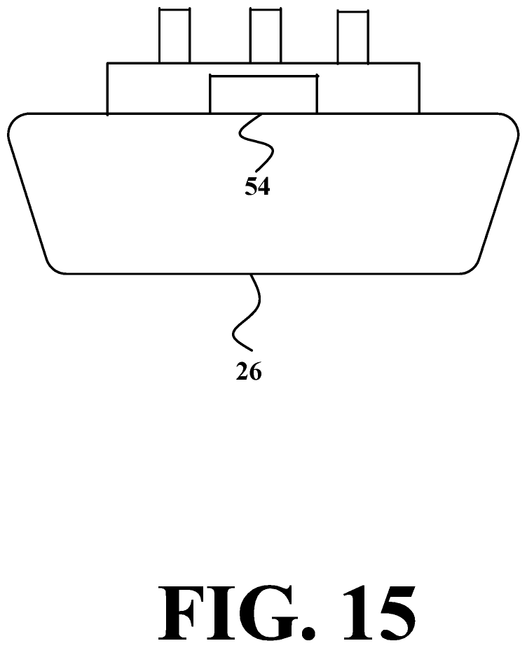

FIG. 15 is a side elevation view of a vessel with a laboratory 54 in the preferred embodiment of the invention. The laboratory is used to analyze the waste material, to determine its type, chemical and physical makeup, identity, and origin.

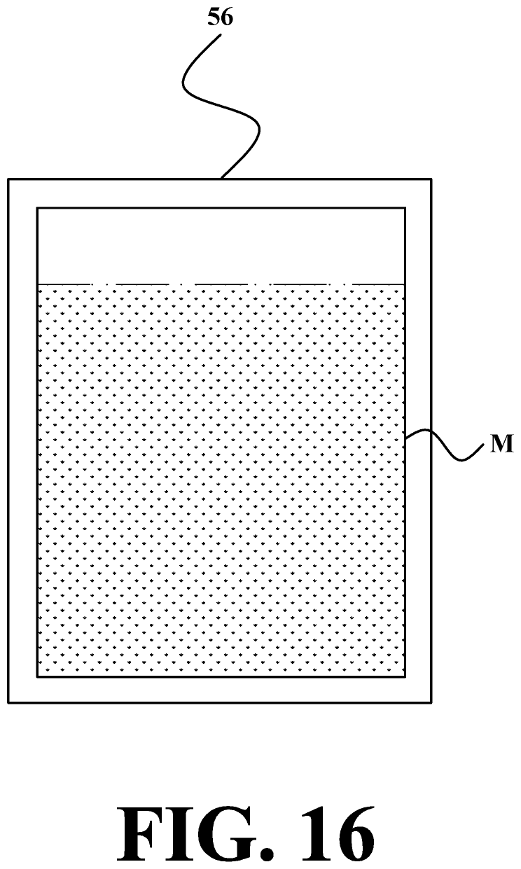

FIG. 16 is a front elevation view of a chamber 56 in the preferred embodiment of the invention, showing the waste material M being processed inside the chamber.

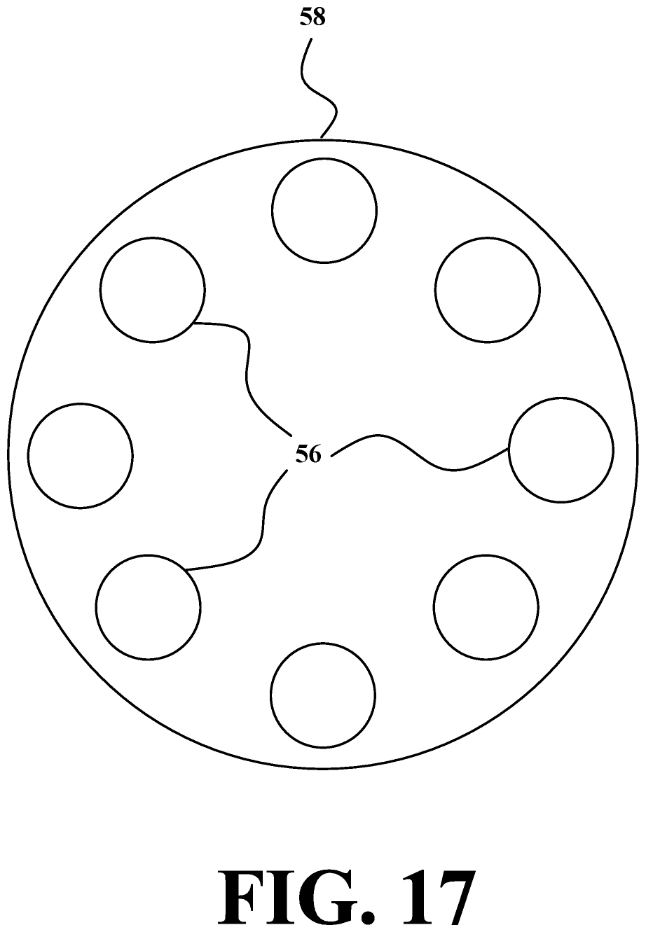

FIG. 17 is a top plan view of a plurality of the chambers 56 on a rotating table 58 in the preferred embodiment of the invention.

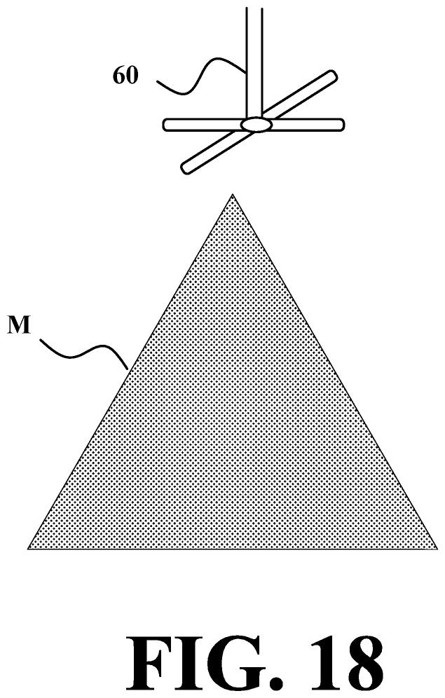

FIG. 18 is perspective view of a 60 dryer removing moisture from waste material M in the preferred embodiment of the invention. Dryers may use fan blades, air, heated air, blowers, vibration, radiation, chemicals, gases, or any other suitable means.

Where metal may be present in the waste material, it should be removed before the waste material is shredded or further processed. First, the waste material is passed under a series of magnets, preferably electromagnets. The magnets gather and release magnetic material (metal that can be magnetically attracted) into a size reducer. The size reducer includes grinders and/or shredders. The magnetic material is reduced in size, preferably to an average diameter of one centimeter or less. It is then stored and recycled.

Particles of the waste material are shredded to a size of no more than one meter at their longest dimension. Pulverization then reduces the average diameter of particles of the waste material to one centimeter or less, preferably one millimeter or less, most preferably one-tenth of a millimeter or less. After it is pulverized, the waste material is placed in a chamber at a temperature greater than one degree Celsius, preferably between 100 and 1600 degrees Celsius. The pressure in the chamber is between 0.25 and 500 times the average pressure of air at sea level. The humidity in the chamber is kept greater than one percent but less than one hundred percent. Radiation and/or catalysts are used in the chamber to enhance the process of discovery. Carbon and water are collected from the chamber and recycled. The carbon may be used as fuel by the vessel or elsewhere. The water is purified, and may be used for drinking, washing, irrigating crops, industrial processes, etc. Where toxic substances are present in the waste material, after it has been processed the first time, it is processed again one or more times, to remove the toxic substances. Chemicals that neutralize or remove the toxic substances may be added to the waste material. After the waste material in a chamber has been completely processed, the chamber is purged (by washing, vacuuming, sweeping, air pressure, agitation, or other suitable means) of all remnants of the waste material, before more waste material is placed in the chamber.

Besides a method for waste management, the invention also includes apparatus for carrying out the method, including:

one or more chambers, within which waste material is:

frozen to a temperature below zero degrees Celsius;

pulverized to maximize the ratio of the surface area to volume of particles of the waste material; and

processed to recover useful material.

The waste material is frozen using freezers, which may be inside or outside of the chambers. The waste material is pulverized using pulverizers, which may be inside or outside of the chambers. The waste material is processed using processors, which may be inside or outside of the chambers. The freezing, pulverization, and processing of the waste material may take place in separate chambers or other spaces.

There can be a plurality of the chambers, that are rotated to enable continuous processing of the waste material. As shown in FIGS. 2 and 3, the apparatus can include a vessel 26 to collect the waste material, having a bow 28 that can open up to a greater width than the vessel's beam, to enable more waste material to be brought into the vessel. The vessel preferably has an inner bow 62 hat prevents water from entering the vessel. As shown in FIG. 3, there are openings 64 in the vessel through which water can be removed from the waste material after it is brought into the vessel. Vessel or other waste collecting vehicles in the invention may be guided by a global positioning system.

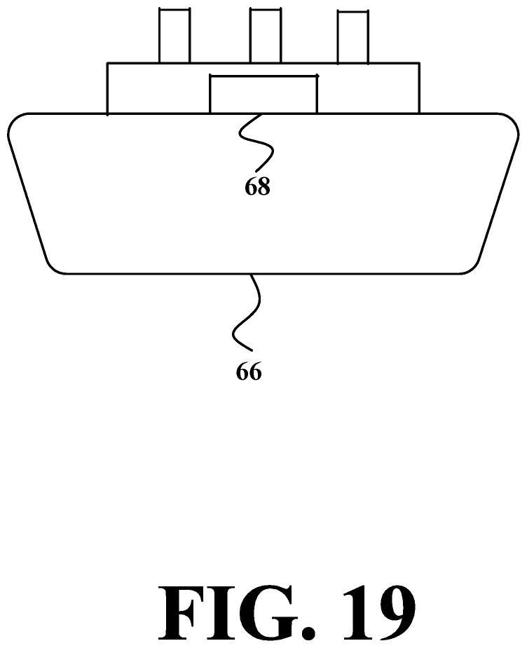

FIG. 19 is a side elevation view of a robotically controlled surface waste collection vessel 66 in the preferred embodiment of the invention, having robotic controller 68.

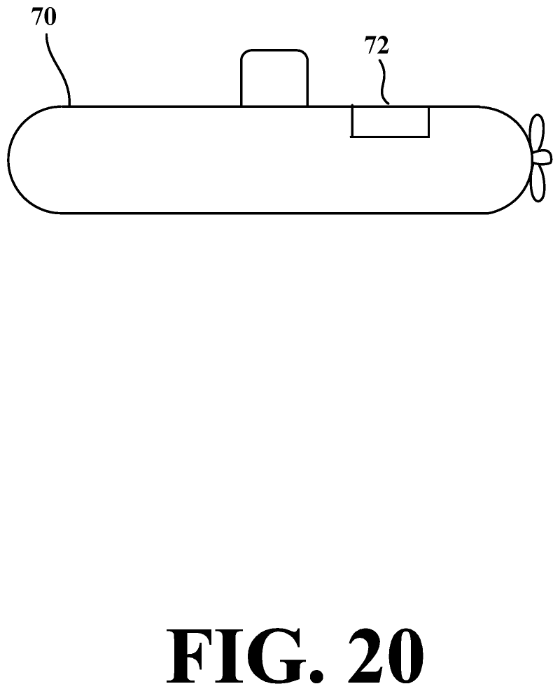

FIG. 20 is a side elevation view of a robotically controlled subsurface waste collection vessel 70 in the preferred embodiment of the invention, having robotic controller 72.

Robotically controlled collection systems may control ships, boats, barges, submarines, jet skis, trains, trucks, cars, etc.

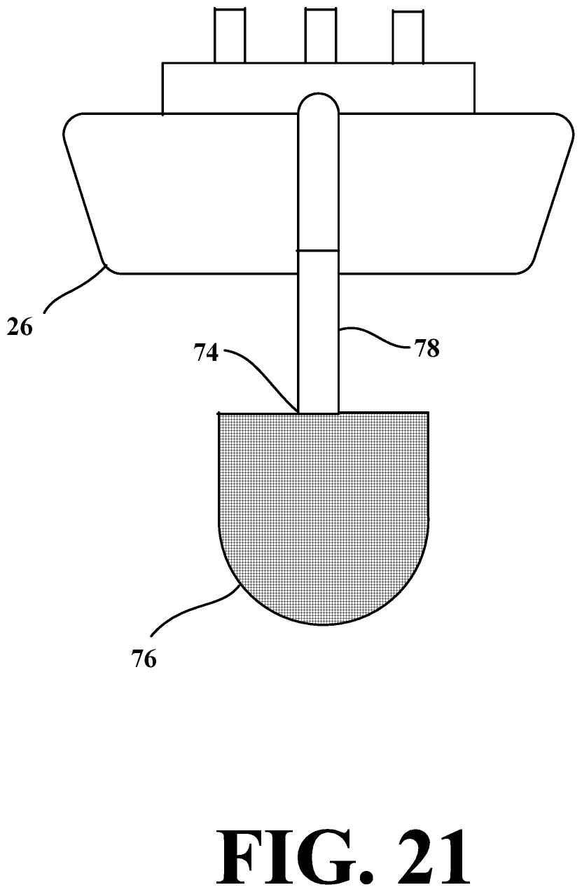

FIG. 21 is a side elevation view of a collecting mechanism 74 in the preferred embodiment of the invention, attached to a vessel 26, with a screen 76, which may be extended at least six meters by telescoping arm 78 or other suitable means. The screen should have apertures with areas no greater than one square millimeters, preferably no greater than 160 square micrometers.

It is to be understood that the present invention is not limited to the embodiment described above, but encompasses any and all embodiments within the scope of the following claims.

1. A process of waste management, comprising the steps of:
collecting waste material;
shredding the waste material;
drying the waste material;
freezing the waste material to a temperature below zero degrees Celsius in one or more chambers;
pulverizing the waste material, to maximize the ratio of the surface area to volume and mass of particles of the waste material;
recycling the waste material by recovering useful material from the waste material; and
storing the recovered useful material.

2. (canceled)

3. The process of waste management according to claim 1, wherein:
the waste material is frozen to a temperature below minus one hundred degrees Celsius.

4. The process of waste management according to claim 3, wherein:
a gas is used in the recovery of the useful material that reacts with the waste material.

5. The process of waste management according to claim 4, wherein:
the gas is a carbon oxide gas, and the waste material and the carbon dioxide gas are heated to a temperature above two hundred degrees Celcius.

6. The process of waste management according to claim 5, wherein:
the waste material includes plastic.

7. The process of waste management according to claim 6, wherein:
the waste material is collected from land.

8. The process of waste management according to claim 6, wherein:
the waste material is collected from water.

9. The process of waste management according to claim 8, wherein:
the waste material is collected from the surface of a body of water.

10. The process of waste management according to claim 8, wherein;
the waste material is collected from the subsurface of a body of water.

11. The process of waste management according to claim 9, wherein:
the waste material is collected using a vessel having a bow that can open up to a greater width than the vessel's beam.

12. The process of waste management according to claim 9, wherein:
the waste material is collected using movement of the vessel.

13. The process of waste management according to claim 9, wherein:
the waste material is collected using current flow.

14. A process of waste management, comprising the steps of:
collecting waste material including plastic from the surface of a body of water;
shredding the waste material;
drying the waste material;
freezing the waste material to a temperature below one hundred fifty degrees Celsius in one or more chambers;
pulverizing the waste material, to maximize the ratio of the surface area to volume and mass of particles of the waste material;
reacting the waste material with carbon dioxide at a temperature above two hundred degrees Celcius; and
storing the waste material;
wherein the waste material is collected using one or more devices selected from the group consisting of paddles, rakes, nets, draglines, buckets, shovels, forks, and spoons.

15. The process of waste management according to claim 14, wherein:
the waste material is collected using one or more conveyor belts to move the waste material.

16. The process of waste management according to claim 15, wherein:
the one or more conveyor belts are capable of movements selected from the group consisting of extension and retraction.

17. The process of waste management according to claim 14, wherein:
the waste material is collected using a vessel having openings through which water can be removed from the waste material after it is brought into the vessel;
wherein in the vessel comprises:
a collector capable of collecting the waste material;
a system of water troughs, sensors. and integrated laboratory analysis;
a shredder capable of shredding the waste material;
a drier capable of drying the waste material in a continuous process;
a freezer capable of freezing the waste material to a temperature below zero degrees Celsius in one or more chambers;
a pulverizer capable of pulverizing the waste material, to maximize the ratio of the surface area to volume, and to maximize the ration of volume to mass, of particles of the waste material;
recovery apparatus capable of recovering useful material from the waste material;
recycling apparatus capable of recycling the recovered useful material; and
storage apparatus capable of storing the recovered useful material.

18. The process of waste management according to claim 14, wherein:
the waste material is monitored by drones.

19. The process of waste management according to claim 14, wherein:
the waste material is monitored by cameras mounted on one or more vessels.

20. The process of waste management according to claim 14, wherein:
the waste material is analyzed using one or more laboratories in one or more vessels.

21. The process of waste management according to claim 14, wherein:
moisture is removed from the waste material after it is collected.

22. The process of waste management according to claim 14, wherein:
particles of the waste material are shredded to a size of no more than one meter at their longest dimension.

23. The process of waste management according to claim 17, wherein:
pulverization reduces the average diameter of particles of the waste material to one centimeter or less.

24. The process of waste management according to claim 23, wherein:
pulverization reduces the average diameter of particles of the waste material to one millimeter or less.

25. The process of waste management according to claim 24, wherein:
pulverization reduces the average diameter of particles of the waste material to less than twenty micons.

26. The process of waste management according to claim 25, wherein:
after it is pulverized, the waste material is placed in a chamber at a temperature greater than one degree Celsius.

27. The process of waste management according to claim 26, wherein:
the temperature in the chamber is between 200 and 800 degrees Celsius.

28. The process of waste management according to claim 27, wherein:
the pressure in the chamber is greater than one hundred times the average pressure of air at sea level.

29. The process of waste management according to claim 28, wherein:
the humidity in the chamber is kept less than ten percent.

30. The process of waste management according to claim 29, wherein:
radiation is used in the chamber to enhance the process of recovery.

31. The process of waste management according to claim 29, wherein:
one or more catalysts are used in the chamber to enhance the process of recovery.

32. The process of waste management according to claim 29, wherein:
carbon and water are collected from the chamber and recycled.

33. The process of waste management according to claim 32, wherein:
the carbon is used as fuel.

34. The process of waste management according to claim 32, wherein:
the water is purified.

35. The process of waste management according to claim 29, wherein:
after waste material has been processed a first time, it is processed again one or more times, to remove toxic substances.

36. The process of waste management according to claim 29, wherein:
after waste material has been processed, the chamber is purged of all remnants of the waste material, before more waste material is placed in the chamber.

37. An apparatus for waste management, comprising:
a collector capable of collecting waste material;
a shredder capable of shredding the waste material;
a drier capable of drying the waste material;
a freezer capable of freezing the waste material to a temperature below zero degrees Celsius in one or more chambers;
a pulverizer capable of pulverizing the waste material, to maximize the ratio of the surface area to volume of particles of the waste material;
recovery apparatus capable of recovering useful material from the waste material;
recycling apparatus capable of recycling the recovered useful material; and
storage apparatus capable of storing the recovered useful material.

38. The apparatus for waste management according to claim 37, wherein:
there are a plurality of the chambers, and they are rotated to enable continuous processing of the waste material.

39. The apparatus for waste management according to claim 37, further comprising:
a vessel to collect the waste material, having a bow that can open up to a greater width than the vessel's beam.

40. The apparatus for waste management according to claim 39, wherein:
the vessel has an inner bow that prevents water from entering the vessel.

41. The apparatus for waste management according to claim 37, further comprising:
one or more waste material collection devices selected from the group consisting of pumps, paddles, rakes, nets, draglines, buckets, shovels, forks, and spoons.

42. The apparatus for waste management according to claim 37, further comprising:
a conveyor belt that can be raised and angled to move the waste material into the vessel.

43. The apparatus for waste management according to claim 37, further comprising:
openings in the vessel through which water can be removed from the waste material after it is brought into the vessel.

44. The apparatus for waste management according to claim 37, further comprising:
drones to monitor the waste material.

45. The apparatus for waste management according to claim 37, further comprising:
ship-mounted cameras that monitor the waste material.

46. The apparatus for waste management according to claim 37, further comprising:
a ship lab to analyze the waste material.

47. The apparatus for waste management according to claim 37, further comprising:
dryers that can remove moisture from the waste material after it is collected.

48. The apparatus for waste management according to claim 37, further comprising:
waste collecting vehicles that are guided by a global positioning system.

49. The apparatus for waste management according to claim 37, further comprising:
surface transportation that is robotically controlled.

50. The apparatus for waste management according to claim 37, further comprising:
one or more subsurface waste collection devices that are robotically controlled.

51. The apparatus for waste management according to claim 37, further comprising:
one or more collecting mechanisms with screens having apertures with areas no greater than one square millimeter.

52. The apparatus for waste management according o claim 37, further comprising:
one or more collecting mechanisms with screens having apertures with areas no greater than 160 square micrometers.

53. The apparatus for waste management according to claim 52, wherein:
the collecting mechanisms may be extended at least six meters.
